(19) United States
(12) Patent Application Publication
(10) Pub. No.: US 2003/0195888 A1
(43) Pub. Date: Oct. 16, 2003

(54) Database linking method and apparatus

(75) Inventors: David Croft, Heidelberg (DE); Stefan Richter, Heidelberg (DE)

Correspondence Address: ARENT FOX KINTNER PLOTKIN & KAHN, 1050 CONNECTICUT AVENUE, N.W., SUITE 400, WASHINGTON, DC, 20036, US

(73) Assignee: Lion Bioscience AG

(21) Appl. No.: 10/425,015

(22) Filed: Apr. 29, 2003

Related U.S. Application Data
(63) Continuation of application No. 09/688,174, filed on Oct. 16, 2000, now abandoned.

(51) Int. Cl. G06F 17/30

(52) U.S. Cl. 707/10

(57) ABSTRACT

a method and apparatus is provided for creating links between otherwise unlinked databases. The process for creating these links may be initiated by selecting text in a source database where it would be desirable to have a link originate. Thereafter, searching at least one target database for information related to the selected text. Associating address information for each related information block with the selected text in the source database to create a link.

### BACKGROUND

1. Field of the Invention

This invention relates generally to the field of electronic databases and more specifically to methods and apparatus utilized to create and navigate links between databases.

2. Background of the Invention

There are a large number of electronic databases available. Some of these databases were created as stand-alone databases and thus, have no links that indicate that additional information is available at other locations. Other databases have embedded electronic links or text links to other related databases. These links were verified and then inserted during the construction of the database.

For example, the protein database “SwissProt” contains links to corresponding entries in the “ENZYME” database, if the protein shows enzymatic activity. Thus, if an individual is interested in the enzymatic activity at the protein found in “SwissProt,” then the link to the “ENZYME” database could be followed to obtain information on the enzymatic activity.

Despite creating databases with links, these link often only provide a link to one other database that was known and usually verified by the database creator to contain valuable and related information. However, there is currently no method available to create links between two databases that were not linked by one of the database creators.

### SUMMARY OF THE INVENTION

The present invention solves the problems discussed above and provides a method and apparatus for creating links between otherwise unlinked databases. The process for creating these links may be initiated by selecting text in a source database where it would be desirable to have a link originate. Thereafter, searching at least one target database for information related to the selected text. Associating address information for each related information block with the selected text in the source database to create a link.

### BRIEF DESCRIPTION OF THE DRAWINGS

FIG. 1 illustrates an exemplary link between two databases.

FIG. 2 provides a high-level function flow diagram of the method utilized to create the links in the current invention.

FIG. 3 provides an example of the structure of an SRS parser file that may be utilized to execute the invention shown in FIG. 2.

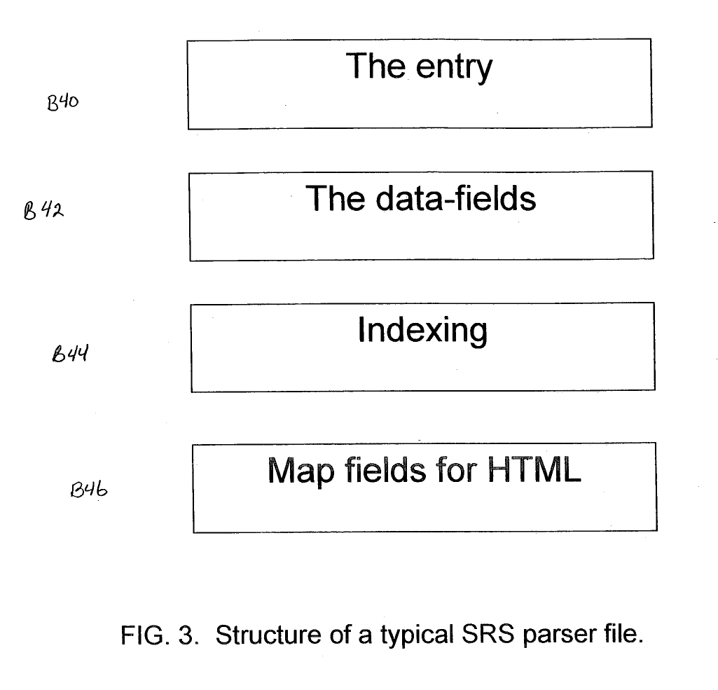

FIG. 4 provides an example of an SRS parser file whose structure is shown in FIG. 3.

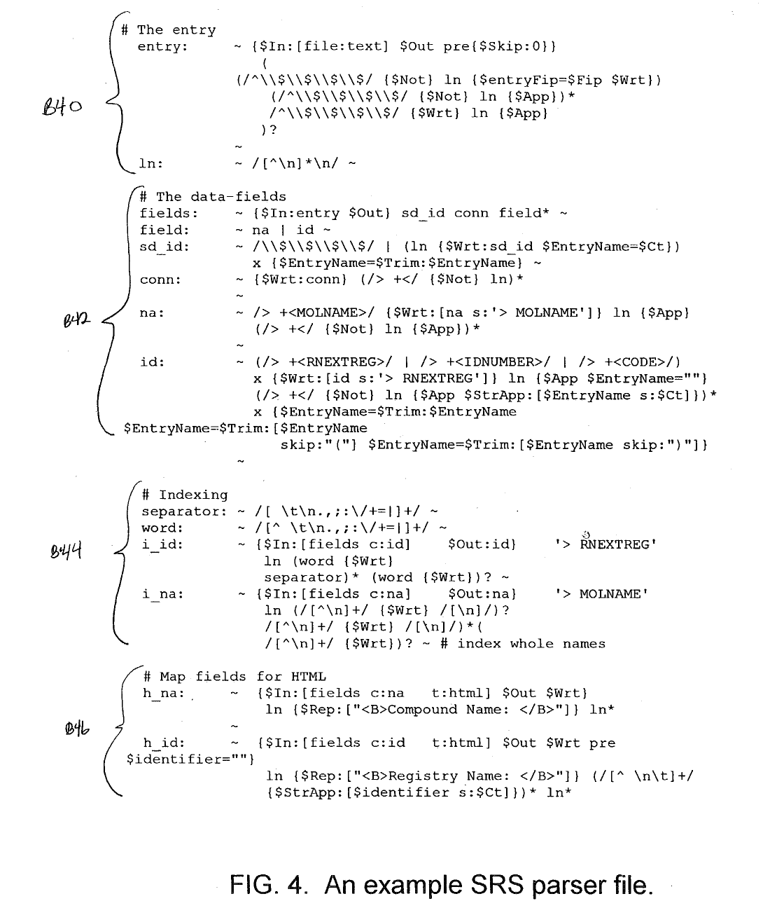

FIG. 5 illustrates a portion of screen capture from the WDI database with a link to SwissProt created by the present invention.

FIG. 6 illustrates a screen capture after the user selected the link show in FIG. 5.

FIG. 7 illustrates a screen capture after the user selection one at the links shown in FIG. 6.

### DESCRIPTION OF THE INVENTION

Definitions

Database means any database, data bank, table, or other collection of structured or unstructured information.

Link means any navigational device, connection, or method utilized to move between pieces or groups of information including but not limited to hyperlinks.

Rich Link means any automatically generated link.

Clicking means any method of selecting and/or activating a link.

Overview

Rich links facilitate serendipity and the discovery of new information, but because human experts do not insert them, they cannot be treated as 100% reliable. Given an appropriate Graphic User Interface (GUI), rich links are intuitively meaningful to a user. For example, from a GUI displaying the source database entry, the user may see links originating from given words in the text, and it is immediately clear why those links are there. Following those links then leads to related entries in the target database(s). Rich links allow experts in one field to delve into databases containing information from fields where they have little knowledge or even no knowledge or where the source and target database creators did not provide links between the databases.

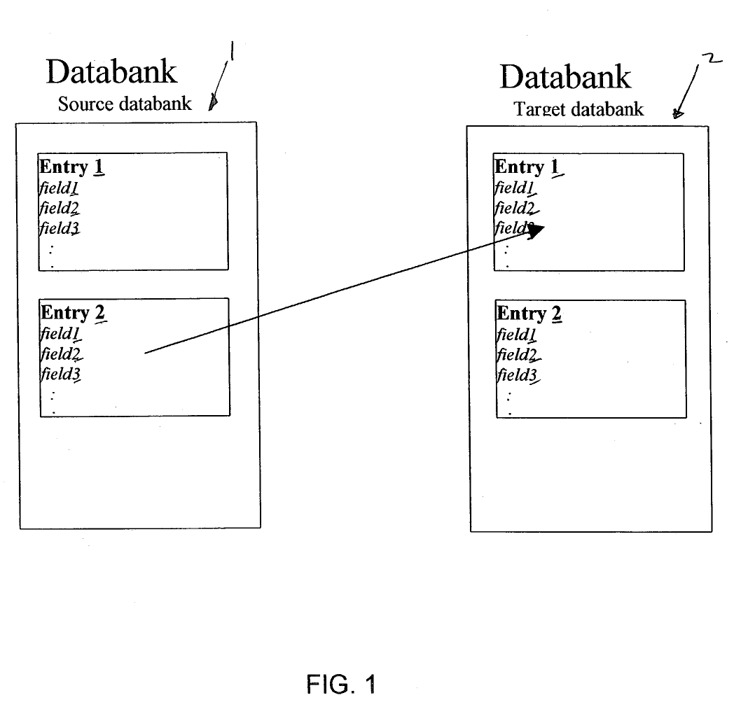

A rich link connecting two databases, Database 1 and Database 2 is shown schematically in FIG. 1. Field 2 in entry 2 in Database 1 is connected by a rich linking algorithm to field 3 in entry 1 in Database 2. In the example, the rich linking algorithm has found a valid reason to insert a link between entry 2 in Database 1 and entry 1 in database 2. It has found no reason to connect other entries, hence it has not inserted any other links.

Exemplary Embodiment

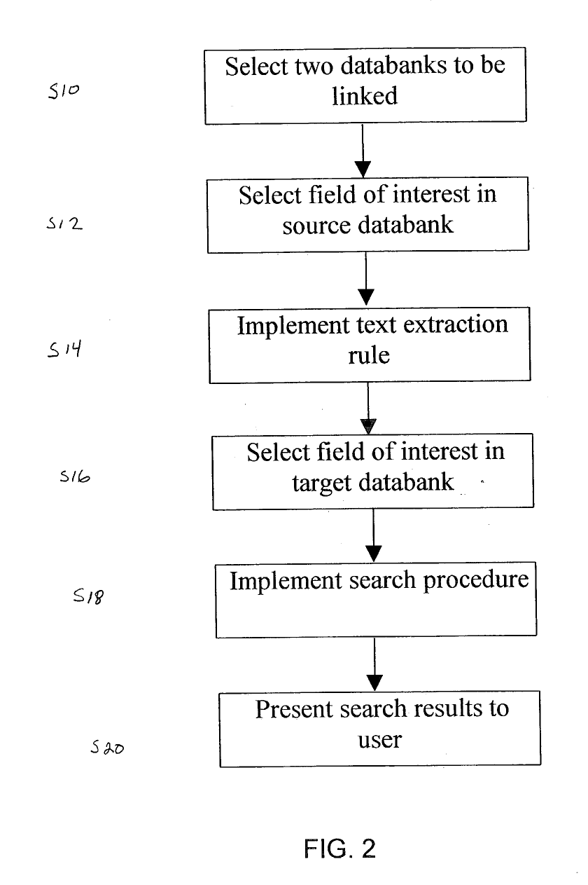

FIG. 2 shows how the links illustrated in FIG. 1 are implemented. Generally, the task of implementing these links will be performed by a database administrator or by the supplier of the databases. However, in some embodiments, the user may be able to create their own links.

In the preferred embodiment, a source and a target database are selected at Step S10. The preferred selection criteria to be applied are:

Valuable information should emerge from the link between the two databases. For example, linking a protein database to a chemical compound database could reveal compounds that may bind to the protein and therefore serve as potential starting points in the search for lead compounds in drug development.

There should be no existing link between the two databases.

In some embodiments, multiple source and target databases may be selected. Selecting a larger number of databases, however, increases the time required to create rich links. Once the database(s) have been selected, a field (or fields) in the source database may be selected as a link start point. In the preferred embodiment, the field of interest in a source database is selected in step S12. In other embodiments this step may be optional. This step, while optional, reduces the time required to identify the text utilized to search the target database(s).

When a field is selected, it is preferred that the field selection be based on selecting a field containing terms that are likely to be relevant to the subject area of the target database. For instance, one might have chosen the WDI (World Drug Index, a database of pharmaceuticals) as a source database, and OMIM (Online Mendelian Inheritance in Man, a database of inherited diseases) as a target database. In the WDI, the Indications (IU) field specifies what kinds of symptoms or diseases a drug can be used to treat, which is likely to contain terms that crop up in OMIM.

The text extraction rule is implemented in step S14. Depending on the nature of the selected field in the source database, some processing of the text may be necessary to extract a list of terms which can be used for searching in the target database(s). To continue with the WDI/OMIM example introduced above, the symptoms and diseases in the Indications field are separated by colons, so this field will need to be parsed to pull out the phrases between colons and put them into a list.

A more complex case arises when one tries to determine to which proteins a given substance in the WDI could bind. In this case, one could attempt to make a rich link from the WDI to SwissProt or to Geneseq, a database of patented biological sequences from Derwent. Here, one could select the Activity Class (PT) field in the WDI as a starting point for a link. This field contains free-form text. A typical phrase in this field might be “Carbonic anhydrase inhibitor”. The presence of the key word “inhibitor” here alerts one to the fact that the drug in question in all likelihood inhibits a protein—in the present example, the protein “carbonic anhydrase”. Thus, for this field, a text extraction rule can be implemented that looks for a set of keywords (“inhibitor”, “agonist”, “antagonist”, “cofactor”, etc.) and then pulls out the phrase preceding that keyword. Each phrase found in this way is then added to the list of terms to be searched for in the target database.

The field of interest in target database is selected in step S16. Knowing the kinds of terms or phrases generated by the text extraction rule, it is generally fairly easy to select a field in the target database where these phrases are likely to be found. For instance, the Keywords and Symptoms fields in OMIM both contain names of diseases or symptoms, which make them suitable targets for a search using the phrases extracted from the Indications field of the WDI. This step, similar to step S12, is optional, but reduces the amount of time required to create a rich link.

The search procedure is implemented at step S19. The phrases obtained from the text extraction of the source database are utilized as search terms in the target database. In the preferred embodiment, as discussed above, these terms would be utilized to search the selected field(s) of the target database(s). Thereafter, the results of the search are presented to user at step S20. This would typically be done in a GUI, which would initially show an entry in the source database. Words or phrases that had been underlined or otherwise highlighted may indicate links. These words or phrases could be the ones found by the text extraction rule. Additional information may be inserted into the text, perhaps in brackets, indicating the name of the target database, and possibly also the names of fields in the target database that have been searched.

Clicking on the underlined or highlighted word, or one of the field names, if more than one field is searched in the target database, would then provide the user with a view of the corresponding entry in the target database, or if more than one entry is found by the search procedure, a list of entries could be presented, from which the user could make a selection.

Implementation Under SRS

The following description provides an SRS programmer of ordinary skill in writing SRS parsers sufficient information to implement rich links in SRS.

Under SRS, the entire rich linking process, as shown in FIG. 2 and discussed in the previous section, except for the selection of the databases to be linked, is implemented in the parser file (the is file) of the source database.

In an SRS parser file, a user can specify productions for fields that generate HTML. These fields are one of the mechanisms used by the SRS CGI program, wgetz, to construct web pages on the fly. Having selected a field in the source database, a special HTML production is written to create the rich link. Standard SRS parsing facilities are used to implement the appropriate text extraction rule. For each word or phrase found, the HTML href mechanism is used to put an underlined word into the URL generated for the current entry. This URL is contained in the code to a call to wgetz that takes the word or phrase found and constructs a search against the selected field(s) in the target database.

When a user views an entry in the source database using SRSWWW (the SRS web GUI), he will see underlined words corresponding to the words or phrases found by the text extraction rule. Clicking on one of these causes the code that calls wgetz to be activated; wgetz generates a new URL; and performs a search for the selected word or phrase against the target database. The user may be presented with a list of hits, which correspond to entries for which the query match was successful. The user may select one of these hits to examine the complete entry.

The structure of a typical SRS parser file is shown in diagram 3. An example of an implementation is shown in diagram 4. In this diagram, the start of each block is indicated by a comment line that begins with a # symbol and may contain the same text as the corresponding block in diagram 3. The first block of code, Entry B40, reads in an entire entry. The second block of code, Data-fields B42, is responsible for reading in individual fields. The third block of code, Indexing B44, extracts terms for indexing, and is used to connect to the database description file. The last of the four blocks of code is Map fields for HTML B46. This is the block where rich linking code is typically inserted into the parser. Each production in this block of code processes one field in the database and makes it available for display in an HTML page. A production has the form:

<production name>: ˜<production body>˜

Spaces, tabs or newlines may be used as separators. The “t:html” in the first line of each of the productions in block B46 of the code, tell SRS that the production should be used to construct HTML page(s) as code.

In order to put a rich link into one of these productions, ICARUS code must be inserted that is capable of pulling out terms or phrases that can be searched for in the target database. ICARUS is the scripting language employed in SRS to create parsers. The use of this scripting language is well known to those of ordinary skill in the art of writing SRS parsers, therefore, further description of ICARUS is not required. The simplest code will use regular expressions, but more sophisticated solutions would be possible, where the parsed text is passed to an external text mining program, that returns terms or phrases of interest. Each term or phrase is put into an ICARUS variable $s.

The following line shows the code in the production that decides if a rich link should be inserted or not. This is an example for the case where only one field in the target database is being searched. If more than one field is being searched, the code will be more complex, but the principles used will be the same. For the sake of illustration, the target database has been named TargDbName and the field being searched in the target database has been named TargDbField. The $Query procedure searches the target database for the string $s in the given field and puts the results into the variable $set. The size of this variable is then checked. Then, only if it is non-zero (i.e. contains 1 or more hits in the target database) is the code block “<insert rich link>” executed.

$set=$Query: “[TargDbName−TargDbField: *$s*]” if: ($set.size>0){<insert rich link>}

The next line gives an example of what could be in the “<insert rich link>” code block. Assuming that only one field in the target database is being searched, and that the rich link should be placed in the text after the term or phrase contained in the variable $s, this line will insert the name of the target database and an underlined HTML link with the name of the field in the target database in brackets.

$Rep:[“$s (TargDbName: <A HREF=wgetz?−newld+−f+id+[TargDbName−TargDbField:*$s*]>TargDbField </A>)”]

A more complex strategy would be necessary if more than one field in the target database is being searched. In general, only fields where search matches to the string $s were found will be inserted. The same basic principles discussed above will also apply to the multiple database and/or multiple field case.

Implementation Under Relational Database Systems

A note on terminology: the “databases” discussed elsewhere in this document correspond to “tables” in relational database systems (RDBMS). The “entries” discussed elsewhere in this document correspond to “rows” in relational database systems. The “fields” discussed elsewhere in this document correspond to “columns” in relational database systems. “Linking” as discussed elsewhere in this document would correspond to establishing “fuzzy foreign keys” in the relational database system. These fuzzy foreign keys can be regarded as implementation of rich links in a RDBMS.

It is possible to implement a basic set of fuzzy foreign keys or rich links in the relational system using standard SQL. Additional database functions or stored procedures applicable only to specific RDBMS implementations may also be used to create rich links between database tables. The information about the rich links may be available as a database view or database snapshot. The link information can be regarded as an additional table that stores the “fuzzy foreign key” relations and therefore the rich links between the two data domains.

To illustrate the embodiment of the invention for relational systems, the WDI/OMIM example from above will be utilized. Assume a representation of the WDI and the OMIM databases are stored in a RDBMS. For simplicity, assume a WDI table with a “WDI_ID” column to uniquely identify an entry (drug) in the WDI table and a “Activity Class” column representing the information about the activity of the drug. Also an OMIM table is assumed to have a unique “OMIM_ID” to identify a disease and a “keyword” column storing a string with the keywords separated by semicolons.

To generate the rich link between these two databases, it is necessary to look for keywords (suffixes or prefixes) in the Activity Class (PT) field of the WDI to identify candidate entries. In the SRS example, a set of keywords is used to find candidate entries for rich links. To exemplify the solution for relational system, only a single keyword (eg. “inhibitor”) for the linking will be used. This will be generalized later in this document. For the identification of the candidates for rich links one could use a query like:

SELECT “WDI_ID”

FROM “WDI”
WHERE UPPER(“Activity Class”) like ‘%INHIBITORS’;

The problem now is that in the keyword field of the OMIM table one would have to look for whatever is matched by the % sign in the above query. This can be achieved using the following join (that could be stored as database view or snapshot):

SELECT “WDI” . “WDI_ID” , ”WDI” . ”drug name”,

”OMIM”. ”OMIM_ID” , ”OMIM” . ”disease”

FROM “WDI”, ”OMIM”
WHERE UPPER(“WDI” . “Activity Class”) like

‘%INHIBITORS’

AND UPPER (“OMIM” . ”keywords”) like

CONCAT (

CONCAT (‘%’,

UPPER (

TRANSLATE (

SUBSTR (“WDI” . ”Activity
Class”,

1,
LENGTH (“WDI” . ”Activity
Class”)
-LENGTH (‘INHIBITOR’) -1

) ,
‘—‘, ’ ’

)

)

) , ’%’

) ;

The above example has the following limitations: 1) it can only extract links where the keyword used to identify the link is a suffix; 2) only a single keyword can be used to establish the link (eg. Inhibitors); and 3) the WDI Activity Class column can not contain more than one activity to make the link work.

The first limitation can be overcome by generation of a similar query for prefixes and use the SQL operator OR to concatenate the query. The second limitation may also be overcome by utilizing additional queries. This of course leads to very complex SQL statements. Since the query itself will be the same first structure it is possible to use a keyword table that holds all the keywords that should be used for the linking. Additional columns in this keyword table can indicate if the text processing should be done using the keyword as a suffix or prefix and what characters should be replaced in the SQL translate function. Now the above SQL statement can be reformulated to include this keyword table in the join and refer to the keyword table at all the points which pointed to the ‘%INHIBITORS’ above. Of course there would still be an OR leaf for the prefix and for the suffix keywords.

The third limitation can be overcome by using a procedural language where the procedures can be stored in the RDBMS (for Oracle eg. PLSQL or Java) that first make a query to identify the linking candidates (eg. make a join between the keyword table and the “WDI” table using the “Activity Class” column and the appropriate wildcard appended depending on whether the keyword should be used as suffix, prefix or appears in the middle of the column). The procedure should then loop over all results from this query and make a second query on the target table to identify the links. The result of the second query together with the linked source entry can be filled into a temporary table that can be used to access the link information. The stored procedure to produce the link information can be accessed as database view or can generate a database snapshot.

Appearance of the GUI

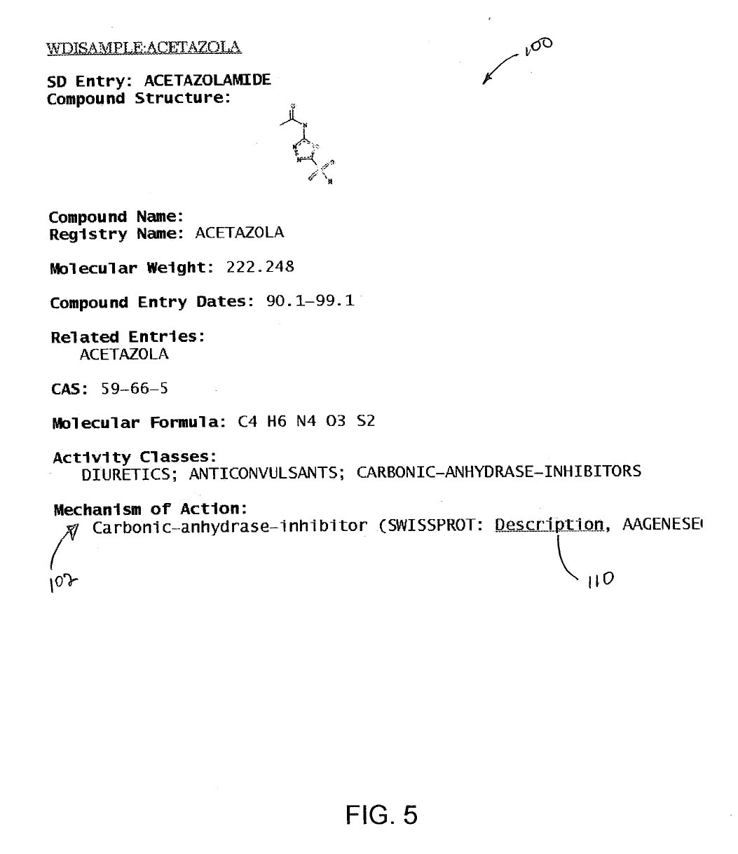

The GUI plays a role in rich linking. It should be intuitively obvious to the user why a rich link is present and what information it is likely to give him. The rich link should be located close to the text, term or phrase of the source database entry used to search in the target database. For an example, FIG. 5 shows a database entry 100 from the WDI. In the “Mechanism of Action” 102 appears the following line:

Carbonic−anhydrase−inhibitor (SWISSPROT: Description, AAGENESEQ: Description)

Several things can be seen in this example. The individual words in the phrase selected by the text extraction rule are connected by hyphens. This allows the user to see at a glance what was used in the search against the target databases. The rich link 110 is inserted into the text directly after the term or phrase selected by the text extraction rule, to make it clear to the user that there is a connection between the term or phrase and the rich link. Each target database is shown in uppercase, so that it is obvious which target databases are being searched. From the names of the databases, it will be clear to the user what kind of information is stored in them, and thus it will be clear to him what kind of information he will be able to retrieve via the rich link 110. The fields in the target databases that get searched are shown underlined, so that the user knows where the search was performed. From this it should be clear why the entry in the target database has been rich linked to the term or phrase selected by the text extraction rule in the source database. In SRSWWW, these fields are clickable, and lead the user to a list of entries in the target database for which the search produced matches.

Although the above is a convenient way to put rich links 110 into the text of the source database entry 100, it is not the only way this could be done. One could for example imagine putting the rich linking information into the text directly before the term or phrase selected by the text extraction rule. It would also be possible, for instance, to replace the underlined field names with buttons, or with field names having small buttons next to them. In either case, pressing the button presents the user with the matching entries in the target database. One could also imagine leaving the source text untouched, and inserting the rich linking mechanism into a margin. Or, if the entry in the source database is being presented in a tabular way, the rich linking mechanism could be inserted into another column, preferably close to the column where the test of the source database field is displayed. In the latter two cases, some mechanism must be implemented to make it clear to the user why the rich links are present, analogous to the discussion provided above for the WDI example.

Operation Utilizing SRS

For example, rich linking has been implemented under SRS between the following databases:

From the WDI (source database) to OMIM (target database);

From OMIM (source database) to the WDI (target database);

From the WDI (source database) to SwissProt (target database);

From the WDI (source database) to Geneseq (target database).

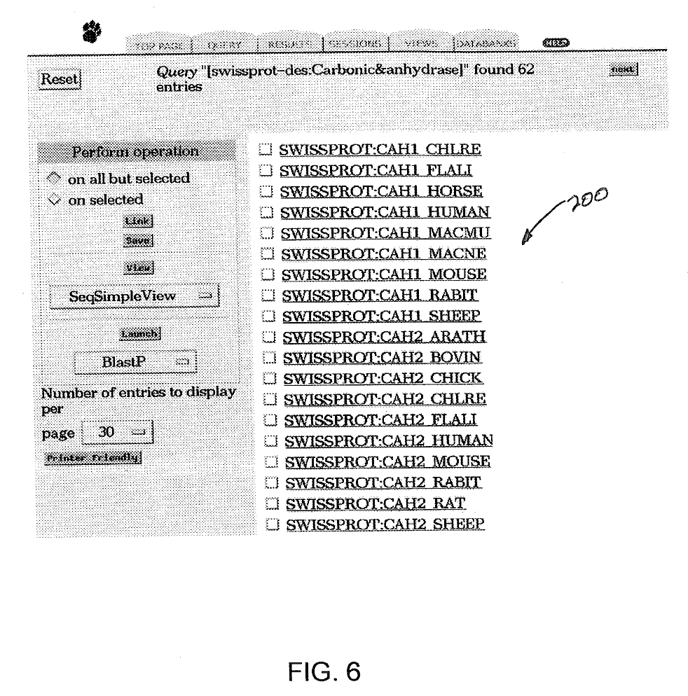

An example of the rich link from the WDI to SwissProt is shown in the set of screen captures illustrated in FIGS. 5-6. In FIG. 5, a WDI entry 100 for ACETAZOLAMIDE is shown. In the lower left hand corner, a rich link 110 is illustrated by the underlined text “Description”. This links the WDI entry 100 to the “SwissProt”, database via the Description field of the SwissProt database.

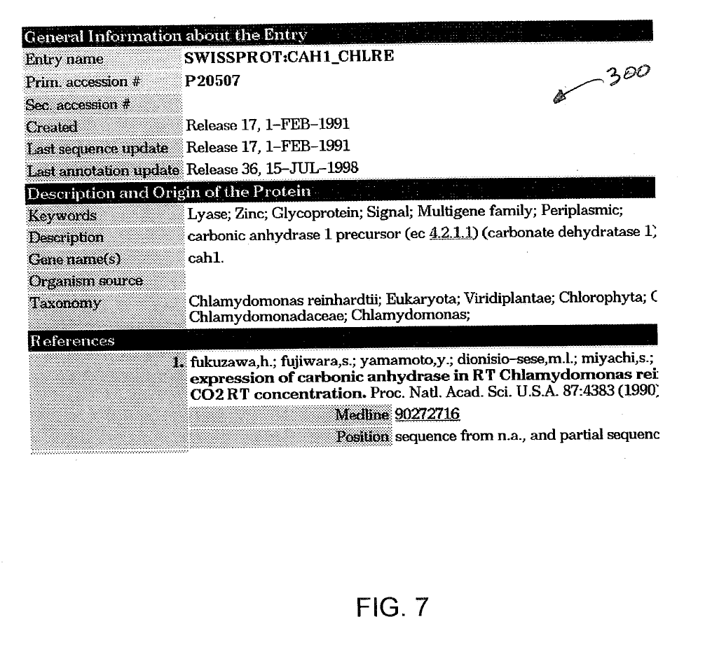

This link was created by utilizing a text extraction rule that looked for the word “inhibitor” and utilizes as a search term the phrase preceding it. In this example, that phrase was “carbonic anhydrase”, which was found in the Description field for multiple SwissProt entries. The result of the user clicking on the “Description” link is shown in FIG. 6 as a list of SwissProt entries 200. Clicking on one of the links underlined words, for example “SWISSPROT:CAHI CHLRE” causes the exemplary page 300 from SwissProt shown in FIG. 7 to be displayed.

Operation Utilizing A RDBMS

To create a link between a source and a target table the follow procedure may be followed. Other procedures that provide the same functionality may be available, and it is expected that these procedures would be obvious to one of ordinary skill in implementing RDBMS systems.

The following tables are assumed and will be linked using the rich link mechanism:

CREATE TABLE ″Source″ (

″S_ID″ INTEGER,
″name″ VARCHAR(100),
″activity″ VARCHAR(255)

) ;
CREATE TABLE ″Target″ (

″T_ID″ INTEGER,
″enzyme″ VARCHAR(100),
″description″ VARCHAR(255)

) ;

For convenience, in using SQL, we create a table that holds the keywords used to setup the links:

CREATE TABLE “link_keywords” (

| | |
|---|---|
| “is_suffix” | VARCHAR(1), |
| “is_prefix” | VARCHAR(1), |
| “keyword” | VARCHAR(100), |
| “transl_from” | VARCHAR(50), |
| “transl_to” | VARCHAR(50) |

) ;

The tables may contain the following sample entries:

INSERT INTO ″Source″ (″S_ID″, ″name″, ″activity″)

VALUES (1, ′Acetazolamide′, ′Carbonic-Anhydrase

Inhibitors′
) ;
INSERT INTO “Target” (“T_ID”, ”enzyme”,”description”)

VALUES (1, ’Water’, ’Solvent’

) ;
INSERT INTO “Target” (“T_ID” , ”enzyme” , ”description”)

VALUES (2, ‘Carbonic Anhydrase’ , ‘CARBONIC ANHYDRASE

1 PRECURSOR (EC 4.2.1.1) (CARBONATE DEHYDRATASE 1)’
) ;
INSERT INTO “link_keywords” (“is suffix” , ”keyword”,

”transl_from” , ”transl_to”)
VALUES (‘Y’, ’inhibitors’, ’—‘, ’ ‘);

Now the following view is created:

CREATE OR REPLACE VIEW “source_target_link” AS

SELECT DISTINCT

“Source” . “name” “SourceName”, ”Source” . ”S_ID”

“SourceID”,

”Target” . ”enzyme” “TargetName” , ”Target” . ”T_ID”

FROM “Source”, “Target” , ”link_keywords”
WHERE UPPER(“Source” . ”activity”) like

CONCAT (‘%’,UPPER (”link_keywords” . ”keyword”))

AND “link_keywords” . ”is_suffix” = ‘Y’
AND UPPER(“Target” . ”description”) like

CONCAT (

CONCAT (‘%’,

UPPER (

TRANSLATE (

SUBSTR (“Source” . ”activity”,

1,
LENGTH (“Source” . ”activity”)
-LENGTH (“link_keywords” .
”keyword”) -1

) ;
“link_keywords” . ”transl_from”,
”link_keywords” . ”transl_to”

)

)

) , ’%’

) ;

This code leads to the following result in the view “source_target_link”:

SQL> desc ″source_target_link″;

| | | |
|---|---|---|
| Name | Null? | Type |
| ------------------------------- | -------- | ---- |

| | |
|---|---|
| SourceName | VARCHAR2 (100) |
| SourceID | NUMBER (38) |
| TargetName | VARCHAR2 (100) |
| T_ID | NUMBER (38) |

SQL> select ″SourceName″, ″TargetName″ from
″source_target_link″;
SourceName
-------------------------------------------------------
-----TargetName
-------------------------------------------------------
-----Acetazolamide
Carbonic Anhydrase

The view can be extended to include prefixes and additional translations. To extend the list of keywords used to make links between the “Source” and “Target” table one has only to insert entries in the “link_keywords” table.

In summary, numerous benefits have been described which result from employing the concepts of the invention. The foregoing description of an exemplary preferred embodiment to the invention has been presented for the purpose of illustration and description. It is not intended to be exhaustive or to limit the invention to the precise form disclosed. Obvious modifications or variations are possible in light of the above teachings. The embodiment was selected and described in order to best illustrate the principles of the invention and its principal application to thereby enable one of ordinary skill in the art to best utilize the invention in various embodiments and with various modifications as are suited to the particular use contemplated. It is intended that the scope of the invention be defined by the claims appended hereto.

We claim:

1. A method for creating links between independent databases comprising:
selecting at least one source database and at least one target database;
selecting text search parameters;
searching the at least one selected source database utilizing the selected text search parameters;
identify at least one source text and location of the source text that was found utilizing the text search parameters
searching the at least one target database for target text that matches source text, according to text search rules; and
upon matching the target text with the source text, creating a link between the source text and the target text.

2. The method of claim 1 further comprising:
selecting a field from the selected source database; and
searching the selected field of the source database utilizing the selected text search parameters.

3. The method of claim 2 further comprising:
selecting at least one field from the selected target database; and
searching the selected at least one field from the selected target database for target text that matches source text, according to text search rules.

4. The method of claim 3 further comprising:
upon creating a link, identify the source text as having at least one link; and
inserting an identifier identifying at least the target database and field.

5. A method for creating links between databases comprising:
selecting a source database;
selecting a field from the selected source database;
selecting text search parameters;
searching the selected field in the selected source database utilizing the selected text search parameters;
identifing at least one source text and location of the source text that was found utilizing the text search parameters;
selecting at least one target data base;
selecting at least one field from the selected target database;
searching the selected field from the selected target database for target text that matches source text, according to text search rules;
upon matching the target text with the source text, creating a link between the source text and the target text;
upon creating a link, identify the source text as having at least one link and inserting an identifier identifying at least the target database and field.

6. A method for creating links between databases comprising:
selecting at least one source database;
extracting at least one search term from the source database;
selecting at least one target database;
searching the target database using at least one search term extracted from the source database;
inserting a link in the source database, the link connecting each search term in the source database to at least one entry in the target database; and
displaying the link in the source database proximate each search term.
